(19) United States
(12) Patent Application Publication
(10) Pub. No.: US 2026/0189743 A1
(43) Pub. Date: Jul. 2, 2026

(54) PRE-FETCHING AND STORING MEDIA LOCALLY ON CUSTOMER PREMISES EQUIPMENT

(71) Applicants: AT&T Intellectual Property I, L.P., Atlanta, GA (US); AT&T Mobility II LLC, Atlanta, GA (US)

(72) Inventors: Robert Klein, Manchester, CT (US); Brian Gavin, Redmond, WA (US); Ronald Kiefer, Louisville, KY (US); Mats Elf, Kirkland, WA (US); Maulik Shah, Carrollton, TX (US)

(21) Appl. No.: 19/007,088

(22) Filed: Dec. 31, 2024

(51) Int. Cl. H04N 21/433; H04N 21/24; H04N 21/25; H04N 21/458

(52) U.S. Cl. CPC H04N 21/262; H04N 21/2407; H04N 21/251; H04N 21/433

(57) ABSTRACT

A method for pre-fetching and storing media locally on customer premises equipment includes predicting, using a machine learning model that analyzes historical video consumption behavior in a home broadband network, a video content that is likely to be consumed by a user of the home broadband network during a next period of peak demand on a communication service provider network, scheduling a download of the video content to a local storage during a next period of predicted non-peak demand in a cell of the communication service provider network that serves the home broadband network, and downloading, in response to determining that the next period of predicted non-peak demand has occurred, the video content to the local storage.

The present disclosure relates generally to systems for streaming media, and relates more particularly to devices, non-transitory computer-readable media, and methods for pre-fetching and storing media locally on customer premises equipment.

### BACKGROUND

Streaming media platforms, including platforms that stream video, music, podcasts, and other types of media, provide users with a means of consuming media on demand. That is, users may play a media on a streaming platform whenever they choose, and potentially from wherever they choose as long as there is access to an Internet connected device. The convenience of streaming media has made it popular among users, which in turn has given rise to an ever increasing number of platforms through which users may consume different types of media.

### SUMMARY

In one example, the present disclosure describes a device, computer-readable medium, and method for pre-fetching and storing media locally on customer premises equipment. For instance, in one example, a method includes predicting, using a machine learning model that analyzes historical video consumption behavior in a home broadband network, a video content that is likely to be consumed by a user of the home broadband network during a next period of peak demand on a communication service provider network, scheduling a download of the video content to a local storage during a next period of predicted non-peak demand in a cell of the communication service provider network that serves the home broadband network, and downloading, in response to determining that the next period of predicted non-peak demand has occurred, the video content to the local storage.

In another example, a non-transitory computer-readable medium stores instructions which, when executed by a processor, cause the processor to perform operations. The operations include predicting, using a machine learning model that analyzes historical video consumption behavior in a home broadband network, a video content that is likely to be consumed by a user of the home broadband network during a next period of peak demand on a communication service provider network, scheduling a download of the video content to a local storage during a next period of predicted non-peak demand in a cell of the communication service provider network that serves the home broadband network, and downloading, in response to determining that the next period of predicted non-peak demand has occurred, the video content to the local storage.

In another example, a device includes a processor and a computer-readable medium storing instructions which, when executed by the processor, cause the processor to perform operations. The operations include predicting, using a machine learning model that analyzes historical video consumption behavior in a home broadband network, a video content that is likely to be consumed by a user of the home broadband network during a next period of peak demand on a communication service provider network, scheduling an upload of the video content to a local storage of customer premises equipment in the home broadband network during a next period of predicted non-peak demand in a cell of the communication service provider network that serves the home broadband network, and uploading, in response determining that the next period of predicted non-peak demand has occurred, the video content to the local storage.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for pre-fetching and storing media locally on customer premises equipment, in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure pre-fetches and stores media locally on customer premises equipment. As discussed above, streaming media platforms, including platforms that stream video, music, podcasts, and other types of media, provide users with a means of consuming media on demand. That is, users may play a media on a streaming platform whenever they choose, and potentially from wherever they choose as long as there is access to an Internet connected device. The convenience of streaming media has made these platforms popular among users, which in turn has given rise to an ever increasing number of platforms through which users may consume different types of media.

Data consumption on both mobility and fixed (e.g., fiber, cable, or the like) networks tends to be cyclical. That is, demand (e.g., in terms of data traffic) on the network may experience peaks during which the demand is significantly higher than at other times. Often, an operator of a network will provision the network with sufficient capacity to handle the times at which demand is highest; however, this may leave much excess capacity during non-peak times that simply goes to waste. These wasted resources increase the costs of operating the network. Moreover, demand may still exceed the increased capacity, leaving users dissatisfied with the network performance. These problems are exacerbated in networks which carry predominantly video traffic (which is often the case with modern mobility and fixed networks).

In many mobility and fixed networks, data consumption across the network tends to increase in the morning hours (e.g., 6:00 AM- 7:00 AM local time) and remain elevated well into the evening hours (e.g., 7:00 PM-8:00 PM local time). This effect is even more pronounced in home broadband networks, whether the access technology used by the home broadband networks is wireless or wired. Data tends to suggest that a significant portion of the daily data consumption in home broadband networks is concentrated within a few hours in the evening (e.g., 8:00 PM-10:00 PM local time). This peak demand is often driven by video consumption in the home. To meet this peak demand, the network operator must either invest resources and money in growing the network or limit the sale of home broadband services in locations where network capacity is close to exhaustion. Another option is to reduce the bitrate of the video data being delivered to the home broadband networks during the peak times; however, this may result in poor video quality for customers.

Examples of the present disclosure augment customer premises equipment in home broadband networks with storage and compute resources, as well as enhanced software for digital rights management (DRM). The compute resources utilize logic driven by machine learning to learn what types of video content are most relevant to the viewing habits within the home broadband network (e.g., what specific video content is most likely to be viewed by users of the home broadband network during the next period of peak network demand, such as the next evening). The compute resources may control the customer premises equipment to download the identified video content (e.g., chunks) during the next predicted non-peak period of network demand and to temporarily store the video content in the storage resources.

In further examples, the compute resources and logic could be implemented on the network provider side, e.g., in an application server that utilizes machine learning to learn what types of video content are most relevant to the viewing habits within multiple home broadband networks. The application server may then instruct the customer premises equipment to download the identified video content, or instruct the providers of the identified video content (e.g., steaming media services, social media sites, etc.) to push the video content to the local storage of the customer premises equipment.

In a further example still, the compute resources and logic could be implemented by the providers of the video content (e.g., in content servers, television servers, application servers, or the like). In this case, application programming interfaces (APIs) on the customer premises equipment may allow content providers who are registered with the customer premises equipment to identify content of the content providers that is relevant to the viewing habits with the home broadband network served by the customer premises equipment. The content providers may then instruct the customer premises equipment to download the identified content or may push the identified content to the local storage of the customer premises equipment. In some examples, the APIs may allow the content providers to determine how much storage is currently available in the local storage.

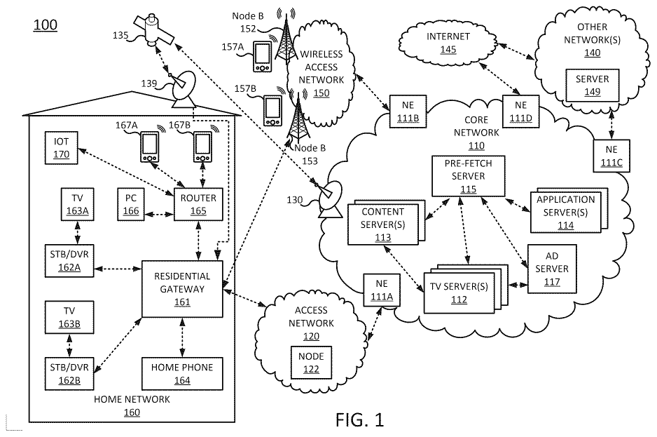

Thus, examples of the present disclosure may allow users of a home broadband network to consume media (such as video content) during times of peak network usage, with little to no latency. The disclosed approach also reduces demand on the network during the times of peak network usage, thereby minimizing the costs associated with expanding network capacity. Thus, examples of the present disclosure make efficient use of existing network resources while maintaining quality customer experience. These and other aspects of the present disclosure are discussed in greater detail in connection with FIGS. 1-3, below.

To better understand the present disclosure, FIG. 1 illustrates an example network 100, related to the present disclosure. As shown in FIG. 1, the network 100 connects mobile devices 157A, 157B, 167A and 167B, and home network devices such as residential gateway 161, set-top boxes (STBs) 162A, and 162B, television (TV) 163A and TV 163B, home phone 164, router 165, personal computer (PC) 166, Internet of Things (IoT) device 170, and so forth, with one another and with various other devices via a core network 110, a wireless access network 150 (e.g., a cellular network), an access network 120, other networks 140 and/or the Internet 145.

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE), “fifth generation” (5G), or any other yet to be developed future wireless/cellular network technology including “beyond 5G” (B5G) and further generations. Thus, elements 152 and 153 may each comprise a Node B, evolved Node B (eNodeB), or a next generation Node B (gNodeB).

In one example, each of the mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and a pre-fetch server 115. For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may interact with content servers 113, advertising server 117, and pre-fetch server 115 to select which video programs, or other content and advertisements to provide to the home network 160 and to others.

In one example, content servers 113 may store scheduled television broadcast content for a number of television channels (e.g., live sports content provided via video streaming platforms), video-on-demand programming, local programming content, gaming content, and so forth. The content servers 113 may also store other types of media that are not audio/video in nature, such as audio-only media (e.g., music, audio books, podcasts, or the like) or video-only media (e.g., image slideshows). For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to viewers, e.g., in the home network 160 and at other downstream viewing locations. For example, advertisers may upload various advertising content to the core network 110 to be distributed to various viewers.

In one example, pre-fetch server 115 may execute operations to predict (e.g., in conjunction with a machine learning model) video content (or other media content) stored in the core network 110 (e.g., at TV servers 112, content servers 113, application servers 114, ad server 117, or the like) that is likely to be consumed by a user in the home network 160 within a defined period of time (e.g., the next twenty four hours). The operations may further schedule download of the video content to local storage of the residential gateway 161 during an upcoming period of non-peak demand in the core network 110. For instance, the operations may send an instruction to the residential gateway 161 to download the video content during the upcoming period of non-peak demand, or may send an instruction to the source of the video content (e.g., TV servers 112, content servers 113, application servers 114, ad server 117, or the like) to push the video content to the local storage of the residential gateway 161 during the upcoming period of non-peak demand.

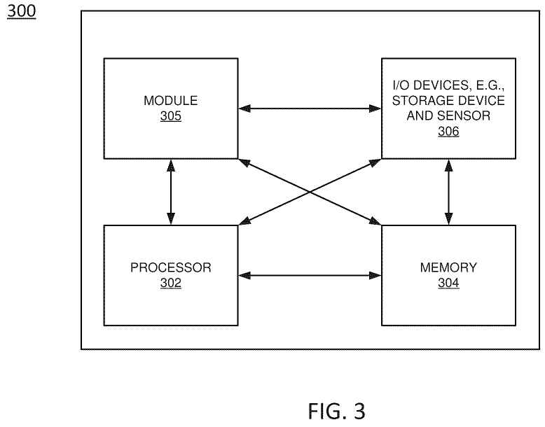

In another example, the operations to predict the video content and to download the video content to the local storage of the residential gateway 161 could be performed by the source(s) of the video content (e.g., TV servers 112, content servers 113, application servers 114, ad server 117, or the like). For instance, the source(s) of the video content may have unique visibility into the viewing habits of users within the home network 160. In one example, the source(s) of the video content may register with APIs at the residential gateway 161 to enable the source(s) to push video content to the local storage of the residential gateway 161. In one example, any or all of the television servers 112, content servers 113, application servers 114, pre-fetch server 115, and advertising server 117 may comprise a computing system, such as computing system 300 depicted in FIG. 3.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a residential gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A and 167B, IoT device 170, and so forth. In one example, router 165 may further communicate with TV (broadly a display) 163A and/or 163B, e.g., where one or both of the televisions is a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

According to examples of the present disclosure, the residential gateway 161 may include local compute (processing) and storage (memory) resources. For instance, the residential gateway 161 may be configured as illustrated in FIG. 3. The local compute resources of the residential gateway 161 may execute operations to predict (e.g., in conjunction with a machine learning model) video content (or other media content) stored in the core network 110 (e.g., at TV servers 112, content servers 113, application servers 114, pre-fetch server 115, or the like) that is likely to be consumed by a user in the home network 160 within a defined period of time (e.g., the next twenty four hours). The local compute resources of the residential gateway 161 may further execute operations to schedule download of the video content to the local storage during an upcoming period of non-peak demand in the core network 110.

Alternatively, as discussed above, the residential gateway 161 may omit the compute resources. In this example, a network-side entity (e.g., TV servers 112, content server 113, application servers 114, pre-fetch server 115, and/or ad server 117) may predict the video content stored in the core network 110 that is likely to be consumed by a user in the home network 160 within the defined period of time. In this case, the network-side entity may either instruct the residential gateway 161 to download the video content during the upcoming period of non-peak demand or may instruct the source(s) of the video content to push the video content to the residential gateway 161 during the upcoming period of non-peak demand.

Subsequently, when a user in the home network 160 requests the video content, the video content may be delivered to a device in the home network 160 from the residential gateway 161, rather than from the core network 110. This will reduce the latency experienced by the user during playback of the video content, even if current demand in the core network 110 is relatively high. Moreover, this may lessen demand on the core network 110 during periods of peak demand.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163A and 163B, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth™”, “ZigBee™”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

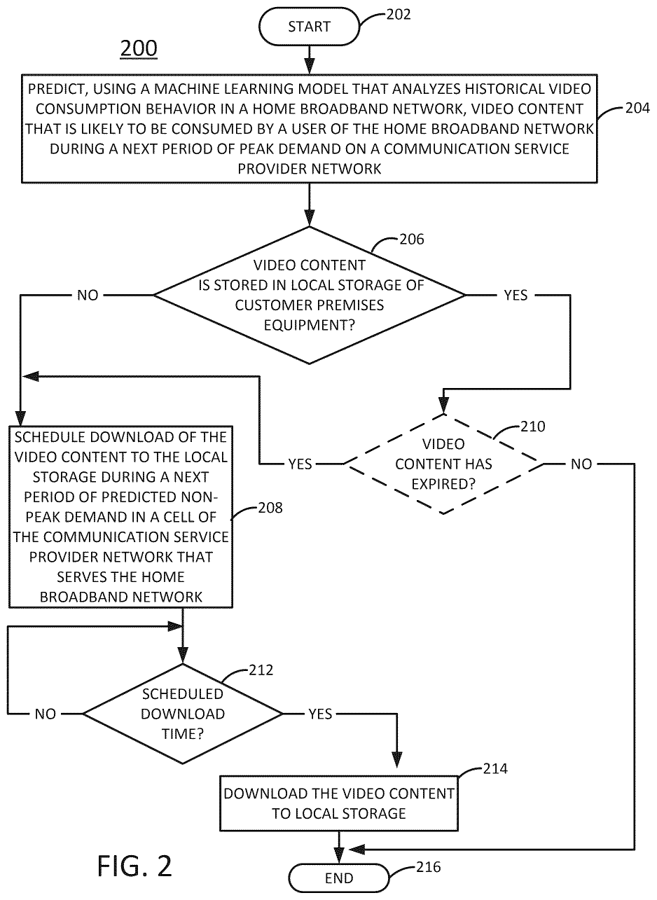

To further aid in understanding the present disclosure, FIG. 2 illustrates a flowchart of an example method 200 for pre-fetching and storing media locally on customer premises equipment, in accordance with the present disclosure. In one example, the method 200 may be performed by customer premises equipment in a home broadband network, such as the residential gateway 161 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may predict, using a machine learning model that analyzes historical video consumption behavior in a home broadband network, video content that is likely to be consumed by a user of the home broadband network during a next period of peak demand on a communication service provider network.

In one example, the processing system may be part of customer premises equipment of the home broadband network. For instance, the customer premises equipment may comprise a residential gateway, a set top box, or the like. In one example, the processing system may comprise local compute resources of the customer premises equipment. The customer premises equipment may additionally include local storage (e.g., a solid state drive or other storage). The customer premises equipment may connect the home broadband network to the communication service provider network. The communication server provider network may comprise a mobility network, a fixed network, or a combination of mobility and fixed networks.

In one example, the machine learning model may comprise any type of machine learning model that is capable of predicting the likelihood that the user will consume given video content based on the historical video consumption behavior. The machine learning model may further be able to predict a specific time (or window of time) during which the user is likely to consume the video content. For instance, the machine learning model may detect a pattern in the historical video consumption behavior that indicates that the user of the home broadband network watches a series that is provided on a streaming video service. The streaming video service may release new episodes of the series every Friday at midnight, and the user may watch the new episodes every Friday after 8:00 PM. Thus, the machine learning model may infer that the user is likely to watch the next episode of the series which is scheduled to be released on the next Friday at midnight, and that the user will watch the next episode after 8:00 PM on the day that the next episode is released.

In one example, the machine learning model may comprise one or more of: a neural network, a support vector machine, a decision tree, a Bayesian network, a linear regression model, a random forest model, and/or another type of machine learning model. In one example, the machine learning model may generate a list of different items of video content (e.g., different episodes of series, different movies, different social media videos, and/or the like). The machine learning model may associate a probability with each item of video content, where the probability comprises a likelihood that the user will watch the item of video content within a predefined period of time (e.g., eighty percent likelihood that the user will watch Video X within the next twenty-four hours). The list may rank the items of video content in order from the item associated with the highest probability to the item associated with the lowest probability.

In step 206, the processing system may determine whether the video content is stored in a local storage of customer premises equipment of the home broadband network.

As discussed above, the processing system may be part of customer premises equipment of the home broadband network that also includes local storage (e.g., a local solid state drive). This local storage may function as a cache for the temporary storage of video content (e.g., stored in chunks). In some cases, the video content may have already been downloaded to the local storage (e.g., in response to a command from the user, or automatically by an earlier iteration of the method 200). Thus, the processing system may check to see if the video content is already in the local storage.

If the processing system concludes in step 206 that the video content is not stored in the local storage of the customer premises equipment, then the method 200 may proceed to step 208. In step 208, the processing system may schedule a download of the video content to the local storage during a next period of predicted non-peak demand in a cell of the communication service provider network that serves the home broadband network.

As discussed above, demand (in terms of volumes of network traffic) on the communication service provider network may experience peaks where demand is significantly higher than at other times (or higher than an average demand, e.g., 8:00 PM-10:00 PM). The communication service provider network may also experience non-peak periods where demand is significantly lower than at other times (or lower than an average demand, e.g., 12:00 AM-6:00 AM). Peak and non-peak demand periods may, in some cases, be highly localized. For instance, while the previous examples may hold true for cells of the communication service provider network that serve suburban neighborhoods, the peak and non-peak periods may be different for cells that serve large college campuses (e.g., where periods of higher demand may last later into the night, for instance beyond 12:00 AM). A machine learning model may learn which periods tend to experience relatively high demand and which periods may experience relatively low demand. Alternatively, the communication network service provider may specify the periods that are considered “peak” and “non-peak” usage times.

The processing system may schedule a download of the video content for a future period of time that is predicted to experience non-peak demand. The download may be scheduled for the next-occurring predicted non-peak period, or for any predicted non-peak period occurring thereafter. For instance, based on the examples above, the processing system may schedule the download to occur between 12:00 AM and 6:00 AM of the next day.

In one example, the communication service provider network may limit the amount of video content (e.g., in gigabytes) that can be downloaded to the local storage. In this case, the processing system may additionally verify that a size of the video content does not exceed the limit. In a further example, the processing system may schedule the download for a portion of the video content, and then download any remaining portions of the video content at a later time.

In step 212, the processing system may determine whether the next period of predicted non-peak demand has occurred.

In one example, the processing system may monitor a clock to determine whether the time for which download of the video content was scheduled has occurred. In another example, another device may notify the processing system when the time for which download of the video content was scheduled has occurred.

In another example, the processing system may monitor the real-time conditions in the communication service provider network and may dynamically identify periods of non-peak demand based on one or more network metrics either exceeding or falling below a predefined threshold. For instance, if the volume of traffic, the latency, or the packet loss of the communication service provider network is currently lower than a predefined threshold, this may signal that it is a good time to download the video content. Similarly, if the throughput is above a predefined threshold, this may also signal that it is a good time to download the video content.

If the processing system concludes in step 212 that the next period of predicted non-peak demand has not occurred, then the processing system may repeat step 212 until the processing system concludes that the next period of predicted non-peak demand has occurred.

Once the processing system concludes in step 212 that the next period of predicted non-peak demand has occurred, the method 200 may proceed to step 214. In step 214, the processing system may download the video content to the local storage.

In one example, the processing system may connect to a source of the video content and may download the video content in whole or in part (e.g., in the form of chunks) to the local storage. In one example, the video content may be permitted to be stored in the local storage for a limited period of time (e.g., thirty days). In this case, the limited period of time begins to count down once the video content is downloaded to the local storage; when the limited period of time expires, the video content must be removed (e.g., deleted) from the local storage.

It should also be noted that digital rights management may restrict the devices on which video content stored in the local storage can be played back.

Once the video content has been downloaded to the local storage, the method may then end in step 216.

Referring back to step 206, if the processing system concludes in step 206 that the video content is stored in the local storage of the customer premises equipment, then the method 200 may proceed to optional step 210. In optional step 210 (illustrated in phantom), the processing system may determine whether the video content has expired.

As discussed above, the video content may be permitted to be stored in the local storage for a limited period of time (e.g., thirty days). Different items of video content may be associated with different limited periods of time, depending on the content providers from which the items of video content were obtained. In this case, the limited period of time begins to count down once the video content is downloaded to the local storage; when the limited period of time expires, the video content must be removed (e.g., deleted) from the local storage. Thus, if the video content was previously downloaded to the local storage, but has since expired, the processing system may need to re-download the video content.

If the processing system concludes in step 210 that the video content has expired, then the method 200 may proceed to step 208, and the processing system may proceed as described above to schedule download of the video content.

If, however, the processing system concludes in step 210 that the video content has not expired, then the method 200 may end in step 216.

When a device in the home broadband network that is connected to the processing system requests video content which is stored in the local storage, the processing system may deliver the video content to the requesting device (e.g., via a WiFi connection) from the local storage (assuming that digital right management associated with the video content does not forbid the requesting device from accessing the video content). Thus the latency to deliver the video content to the requesting device may be minimized, even during times of peak demand in the communication service provider network.

In one example, updated data about the historical video consumption behavior may periodically be provided as new training data to the machine learning model that predicts the video content that is likely to be consumed. This will allow the processing system to adjust to changes in the video consumption behavior, such as users of the home broadband network beginning to watch new series or losing interest in series they previously watched some episodes.

As discussed above, in some examples, some steps of the method 200 may be performed by a network-side entity, such as a server specially configured to perform pre-fetch of predicted video content, or a source of the video content. For instance, the network-side entity may perform steps 204-208. In this case, scheduling of the download of the video content may include either sending an instruction to the customer premises equipment to perform the download during the next period of predicted non-peak demand or sending an instruction to the source of the video content to perform a push of the video content to the customer premises equipment during the next period of predicted non-peak demand. This may minimize the computational resources consumed by the customer premises equipment by pushing the burden of the prediction to the network.

In some examples, applications running on devices in the communication service provider network (e.g., streaming media applications, social media applications, gaming applications, and/or the like) may be able to access application programming interfaces (APIs) on the customer premises equipment. Via these APIs, the applications may be able to determine how much local storage is available on the customer premises equipment. The APIs may also be able to determine the local addresses of any devices in the home broadband network that are connected to the customer premises equipment (e.g., set top boxes, smart televisions, smart phones, tablet computers, and the like). The local addresses may allow the applications to determine which devices in the home broadband network may be capable of playing back different types of media.

In further examples, the APIs may “register” applications with the customer premises equipment, which may allow the applications to poll the customer premises equipment for locally stored content for specific users in the home broadband network.

In further examples of the present disclosure, the customer premises equipment may include logic to predict a device of the home network on which a user is expected to view the video content and/or a location from which the user is expected to view the video content. For instance, the customer premises equipment may observe a pattern by which the user tends to view new episodes of a series from a streaming video service on their mobile devices (e.g., smart phone, tablet computer, or the like) while not connected to the home network (e.g., while commuting on the train after work). In this case, the logic may cause the customer premises equipment to push the video content from the local storage of the customer premises equipment to a storage of the pertinent mobile device, before the pertinent mobile device leaves the user's home network (e.g., before the user leaves his or her home for work in the morning). In this way, the video content may be available for the user to view on his or her mobile device during the time at which the user normally views the video content, even if that time coincides with peak network demand.

In further examples, the customer premises equipment may derive insights into multiple devices'viewing behaviors within a home broadband network. The machine learning model may be trained to receive inputs from all media streaming services that the home broadband network subscribes to, as well as social media accounts of users associated with the home broadband network. Combined viewing behaviors and social media activities could be anonymized and aggregated by the customer premises equipment and made available, via APIs, to content providers (e.g., providers of the media streaming services). This insight may help content providers to better tailor their content to subscriber interests.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Although examples of the present disclosure are discussed within the context of video content, it will be appreciated that the examples disclosed herein could be applied to the consumption of other types of media over a network as well. For instance, examples of the present disclosure could be applied to streaming music, to gaming content, or the like.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, a residential gateway or other customer premises equipment (such as might be used to perform the method 200) could be implemented as illustrated in FIG. 3.

As depicted in FIG. 3, the system 300 comprises a hardware processor element 302, a memory 304, a module 305 for pre-fetching and storing media locally on customer premises equipment, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for pre-fetching and storing media locally on customer premises equipment may include circuitry and/or logic for performing special purpose functions relating to predicting media content that is of interest to users and scheduling download of the media content to local storage. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for pre-fetching and storing media locally on customer premises equipment (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for pre-fetching and storing media locally on customer premises equipment (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
predicting, by a processing system including at least one processor and using a machine learning model that analyzes historical video consumption behavior in a home broadband network, a video content that is likely to be consumed by a user of the home broadband network during a next period of peak demand on a communication service provider network;
scheduling, by the processing system, a download of the video content to a local storage of a customer premises equipment located in the home broadband network during a next period of predicted non-peak demand in a cell of the communication service provider network that serves the home broadband network; and
downloading, by the processing system in response to determining that the next period of predicted non-peak demand has occurred, the video content to the local storage.

2. The method of claim 1, wherein the processing system and the local storage are part of the customer premises equipment that connects the home broadband network to the communication service provider network.

3. The method of claim 1, wherein the machine learning model generates a list of different items of video content including the video content.

4. The method of claim 3, wherein the machine learning model associates a probability with each item of video content of the different items of video content, where the probability comprises a likelihood that the user will watch the each item of video content.

5. The method of claim 4, wherein the list ranks the different items of video content in order from a highest probability to a lowest probability.

6. The method of claim 4, wherein the probability further comprises a likelihood that the user will watch the each item of video content during the next period of peak demand.

7. The method of claim 1, wherein the next period of peak demand and the period of predicted non-peak demand are learned by another machine learning model.

8. The method of claim 1, wherein the next period of peak demand and the period of predicted non-peak demand are specified by an operator of the communication service provider network.

9. The method of claim 1, wherein the local storage stores a portion of the video content up to a maximum storage capacity of the local storage.

10. The method of claim 1, wherein the processing system monitors a clock to determine when the next period of predicted non-peak demand has occurred.

11. The method of claim 1, wherein another device notifies the processing system when the next period of predicted non-peak demand has occurred.

12. The method of claim 1, wherein the processing system dynamically determines when the next period of predicted non-peak demand is going to occur based on monitoring of real-time network conditions in the communication service provider network.

13. The method of claim 12, wherein the next period of predicted non-peak demand is predicted to occur when at least one of: a volume of traffic in the communication service provider network, a latency of the communication service provider network, or a packet loss of the communication service provider network falls below a predefined threshold.

14. The method of claim 12, wherein the next period of predicted non-peak demand is predicted to occur when a throughput of the communication service provider network is above a predefined threshold.

15. The method of claim 1, wherein the video content is permitted to be stored in the local storage for a limited period of time.

16. The method of claim 1, further comprising:
receiving, by the processing system from a device in the home broadband network, a request for the video content; and
delivering, by the processing system in response to the request, the video content to the device from the local storage.

17. The method of claim 1, wherein updated data about the historical video consumption behavior is periodically provided as new training data to the machine learning model.

18. The method of claim 1, further comprising:
aggregating, by the processing system, the historical video consumption behavior with social media activity of the user to produce an aggregated data set;
anonymizing, by the processing system, the aggregated data set; and
providing, by the processing system, the aggregated data set, as anonymized, to a provider of video content.

19. A non-transitory computer-readable medium storing instructions which, when executed by a processor, cause the processor to perform operations, the operations comprising:
predicting, using a machine learning model that analyzes historical video consumption behavior in a home broadband network, a video content that is likely to be consumed by a user of the home broadband network during a next period of peak demand on a communication service provider network;
scheduling a download of the video content to a local storage of a customer premises equipment located in the home broadband network during a next period of predicted non-peak demand in a cell of the communication service provider network that serves the home broadband network; and
downloading, in response to determining that the next period of predicted non-peak demand has occurred, the video content to the local storage.

20. A method comprising:
predicting, by a processing system including at least one processor using a machine learning model that analyzes historical video consumption behavior in a home broadband network, a video content that is likely to be consumed by a user of the home broadband network during a next period of peak demand on a communication service provider network;
scheduling an upload of the video content to a local storage of a customer premises equipment in the home broadband network during a next period of predicted non-peak demand in a cell of the communication service provider network that serves the home broadband network; and
uploading, in response to determining that the next period of predicted non-peak demand has occurred, the video content to the local storage.
